(19) United States
(12) Patent Application Publication
(10) Pub. No.: US 2021/0051978 A1
(43) Pub. Date: Feb. 25, 2021

(54) Animal Feed from Minimally Dewatered Microalgal Slurry

(71) Applicant: SEB Farms, LLC, Wamego, KS (US)

(72) Inventors: Bernard L. Hansen, Wamego, KS (US); Leonard J. Underwood, Regina (CA)

(73) Assignee: SEB Farms, LLC, Wamego, KS (US)

(21) Appl. No.: 16/949,637

(22) Filed: Nov. 9, 2020

Related U.S. Application Data
(62) Division of application No. 15/798,958, filed on Oct. 31, 2017.
(60) Provisional application No. 62/416,576, filed on Nov. 2, 2016.

(51) Int. Cl. A23K 10/10; A23K 20/28; A23K 50/42

(52) U.S. Cl. CPC A23K 10/10; A23K 50/42; A23K 20/28

(57) ABSTRACT

An extruded animal feed comprising minimally dewatered microalgal biomass and a porous mineral is disclosed. The livestock feed comprises a mixture of the porous mineral, such as zeolite, and a whole algal biomass containing between 2.0% to 15.0% solids. The whole algal biomass and the porous mineral are mixed together at a ratio of 1 part whole algal biomass to between 1 to 3 parts porous mineral. The extruded mixture can be formed by extruding the whole algal biomass and the porous mineral together, with or without additional ingredients. The extruded mixture of whole algal biomass and the porous mineral can be delivered as a feed supplement or can be further processed into a final feed composition. The feed supplement may comprise: Zeolite 2.5% to 12%; Microalgal biomass 1.0% to 7.5%; Flax between 40% to 60%; and a dry feed composition between 35% to 55%.

### CROSS REFERENCES

This application claims benefit to U.S. Provisional Application No. 62/416,576, filed on 2 Nov. 2016.

### REFERENCE TO CDS

Not Applicable.

### FIELD OF THE INVENTION

This invention relates to an animal feed supplement and a process of utilizing minimally dewatered algal biomass from an open pond cultivation system to make a feed supplement.

### BACKGROUND

Fatty acids are an integral part of cell membranes throughout the body and affect the function of the cell receptors in these membranes. There are two primary essential fatty acids—fatty acids that the human body cannot produce and must obtain through their diet. The two primary essential fatty acids are linoleic acid (LA)—an omega-6 fatty acid—and alpha-linoleic acid (ALA)—an omega-3 fatty acid. ALA can be used by the human body to synthesize the long chain omega-3 fatty acids eicosapentaenoic acid (EPA) and docosahexaenoic acid (DHA).

Long chain omega-3 fatty acids are widely recognized beneficial to a person's health, including vision and nervous system function. Unfortunately, humans are not efficient at converting ALA to EPA and DHA. That means it is important for humans to eat a diet high in long chain omega-3 fatty acids in order to maximize the healthy long chain poly-unsaturated fatty acids. Foods high in long chain omega-3 fatty acids include seafood and certain seeds and grains.

Instead of requiring the consumer to make substantial diet and lifestyle changes, it is possible for food producers to increase the amount of omega-3 fatty acids in animal products that do not normally contain high levels of omega-3 fatty acids, such as beef, pork, chicken, milk, or eggs.

### SUMMARY

We discovered a method for making a livestock feed from a whole, wet algal biomass—a product that is only minimally dewatered to between 6.0% to 15.0% solids—without the need for expensive, time-consuming steps to chemically isolate the fatty acids or dewatering the algae to a drier, concentrated product. We discovered that a mixture of algal biomass and a porous mineral, such as zeolite, could be dry extruded to form a livestock feed. The resulting livestock feed is easy to transport as a stable, dry material without the unpleasant odors of wet algae. The livestock feed is rich in omega-3 fatty acids and contains a by-pass agent for improving uptake conversion in ruminant animals.

Algae are an abundant source of omega-3 fatty acids. Algae, specifically microalgae, can be grown in a variety of ways, including: open pond systems, tube reactors, photobioreactors, and heterotrophic fermentation. Open pond systems are the most simple and cost effective way to grow algae in sunny areas.

Microalgae are commonly cultivated in open ponds of shallow water, where the algae are exposed to natural solar radiation. The microalgae convert the solar radiation—sunlight—into a biomass containing between 2.0% to 15.0% solids. The concentration of the cultivated product depends on the species of algae, growth conditions, and harvesting method.

The use of microalgae as a source of omega-3 fatty acids in feed and feed supplements is known. However, the known processes for preparing microalgae entail purifying, concentrating, or drying the microalgal prior to using the microalgae as an ingredient.

By dewatering the microalgae through decanting, flocculation, filtering, or a combination thereof, the algal biomass concentration, the concentration of the algae can reach 6.0% to 15.0%. The algae can be further concentrated—or dewatered—by processes such as centrifugation, filtration, or mechanical pressure to remove additional water from the biomass. However, these processes also increase the cost of producing the algae biomass resulting in a feed that is prohibitively expensive for use in general agricultural practices.

We discovered that shear mixing the porous mineral changed the consistency of the algal biomass as the mineral absorbs a portion of the water from the biomass. The mineral may also acts as a bypass agent, which may increase the animal's ability to incorporate the omega-3 fatty acids from the feed into meat and dairy products.

The porous mineral may be, for example, zeolite. Zeolite is a naturally occurring mineral made of volcanic material. There are also synthetic zeolites that have similar chemical composition and physical characteristics. Zeolite's physical structure has many negatively charged pores, linked cages, cavities, and channels throughout. Chemically, Zeolite is a crystalline aluminosilicate.

We observed that mixing whole microalgal biomass and the mineral zeolite together at a ratio of 1 part whole algal biomass to between 1 to 3 parts mineral results in a mixture with a paste-like consistency. This paste-like consistency allows for transportation with augers or conveyors. The microalgal biomass and mineral zeolite can be mixed with other feed components before or after extrusion.

One advantage of the present disclosure is that utilizing whole microalgal biomass is a less expensive source of omega-3 fatty acids than dried microalgae or omega-3 fatty acids isolated from an algal source. Another advantage is microalgal biomass containing between 2.0% to 15.0% solid is readily pumpable in its liquid form. Another advantage is that this microalgal biomass can be transported in kegs or shuttles to the processing location and pumped directly from the kegs or shuttles.

The microalgal biomass is mixed with a porous mineral such as Zeolite. Zeolite is a hydrated aluminosilicate that is known for absorbing moisture. Zeolite is useful as a cation exchanger. The structure of zeolite is highly porous. The zeolite and the microalgal biomass can be mixed in a continuous mixing extruder. Mixing the zeolite and the microalgal biomass at a ratio of 1:1 to 1:4 generates a microalgae-zeolite ingredient having a thick, flowable consistency.

One advantage of mixing the microalgal biomass and the zeolite in a 1:1 to 1:4 ratio is that the zeolite absorbs much of the liquid of the biomass. This is advantageous as the wet, whole microalgal biomass is otherwise too wet. The zeolite may absorb beneficial nutrients and other elements from the biomass. Another advantage of the zeolite is that zeolite affects the fatty acid composition of the animal byproducts and improves animal health.

The microalgal biomass having between 2.0% to 15.0% solids is too wet to add as a standard ingredient in a feed formulation. Utilizing wet microalgal biomass requires proper mixing with the zeolite at proper ratios. We further discovered an efficient means for mixing the dry, particulate zeolite with the wet algal biomass. The algal biomass is pumped from a storage container into a continuous mixing mortar pump, which combines the dry particulate zeolite material with the wet, pumpable algal biomass.

One advantage of this process is that the zeolite absorbs much of the liquid of the microalgal biomass without the added expense of concentrating the microalgae and without losing valuable components of the biomass.

Another advantage of this disclosure is that extruding the mixture reduces the moisture content and stabilizes the mixture. A dry extruder, for example an Insta-Pro International® dry extruder, uses a mechanical process to heat the mixture to the point of gelatinization, cooking, dehydrating, and stabilizing the mixture. The temperature of the mixture during the step of extruding reaches between 270° F. to 300° F. Rapidly cooling the extruded mixture, for example air cooling the extruded mixture, is important to maintain the chemical composition and not break down the valuable omega-3 fatty acids and micronutrients present in the whole algal biomass.

The mixture is then extruded to form a feed supplement. Dry extruding the mixture reduces the moisture content and stabilizes the mixture. A dry extruder, for example an Insta-Pro International® dry extruder, uses a mechanical process to generate pressure and heat the mixture to the point of gelatinization, cooking, dehydrating, and stabilizing the mixture. The temperature of the mixture during the step of extruding reaches between 270° F. to 300° F.

An advantage to extruding the feed supplement is to remove excess moisture from the whole, wet microalgal biomass. Specifically, dry extrusion does not add moisture content. Rather, heating the mixture above the boiling point causes moisture to leave the mixture.

Another advantage to extruding the feed supplement is to provide easily conveyable and stable feed supplement. Extrusion may also work as a bypass to protect omega-3 fatty acids through the rumen.

The extruded mixture is rapidly cooled after being treated to increased heat and pressure in the extrusion step. For example, the extruded mixture is transferred to a cooling and drying unit. Ambient or conditioned air can be introduced to quickly remove moisture and cool the product.

An advantage to rapidly cooling the extruded mixture is to maintain the chemical composition and not break down the valuable omega-3 fatty acids and micronutrients present in the whole algal biomass. Air cooling and drying can be achieved by introducing ambient air.

Animals are fed the feed supplement at between 2% to 10% of their total feed. The supplement can be mixed together with a traditional total feed blended for the specifics of the animal. Total feed blends vary between species, breeds, ages, locations, and other criteria. The total feed can be compensated or credited for the contents of the feed supplement. This credit decreases the price of the total feed, and at least partially offsets the price of the feed supplement. For example, the protein content of the total feed can be decreased based on the protein content of the feed supplement.

Another advantage of feeding an extruded mixture of microalgae-zeolite is that the meat, egg, and dairy products do not take on a fishy or other foul odor. The direct feeding of microalgae can taint the odor of animal products. Feeding an extruded mixture of microalgae-zeolite provides animal products without a fishy or foul odor.

A highly concentrated microalgae-zeolite ingredient can be provided directly to feed mills as a concentrated feed supplement, with or without flax and the dry feed composition. The feed mills would then combine the highly concentrated mixture with standard feed components according to the dietary and taste for desired types or breeds of animals.

We discovered that animals are healthier when fed the feed supplement. Some of the health improvements include: decrease need for antibiotics, decreased need for foot care, and increased rate of breeding in first-calf heifers.

In addition to improving animal health, we discovered that the animal products—poultry, beef, pork, eggs, and dairy—had a marked increase in omega-3 fatty acids, specifically the long chain omega-3 fatty acids, specifically docosahexaenoic acid (DHA) and eicosapentaenoic acid (EPA). This means that a person who normally eats poultry, beef, pork, eggs, and dairy can improve their omega-3 fatty acid consumption without changing their diet. This may help with coronary heart disease, stroke, lupus, eczema, rheumatoid arthritis, cancer prevention, and brain and optical development in children.

In ruminant animals, it is important to provide sufficient bypass agents to allow the omega-3 fatty acids to pass through the rumen so that the omega-3 fatty acids are not degraded in the rumen. The animal is able to incorporate the omega-3 fatty acids from the whole algal biomass into the animal products, including meat, dairy, and eggs. Additionally, the extruded mixture of whole algal biomass and the porous mineral may provide sufficient bypass to protect omega-3 fatty consumed through grazing grasses or other sources of omega-3 fatty acids in the animal's diet. Both the flax seed and the microalgal biomass contain significant quantities of omega-3 fatty acids.

In addition to the microalgal biomass and the porous mineral, the mixture can also comprise between 40% to 60% flax and 35% to 55% of a dry feed composition. The dry feed composition can comprise wheat middlings, whole wheat, ground soy hulls, ground rice hulls, corn feed and mixtures thereof. The exact composition of a total feed will depend on the dietary and taste requirements for specific types or breeds of animal.

Flax, like algae, is a feed source high in omega-3 fatty acids, specifically high quantities of alpha-linolenic acid (ALA). Flax is also high in other nutrients, like the lignan precursor secoisolariciresinol diglycoside. Flax also has a vitamin content similar to soybean meal.

We also discovered a method for preparing the animal feed supplement. The method comprises the steps of:
1. Providing whole, wet microalgal biomass, having between 2.0% to 15% solids;
2. Providing zeolite;
3. Mixing the microalgal biomass with the zeolite at a ratio between 1:1 and 1:3 using a continuous mixer;
4. Dry extruding the mixture at a temperature between 270° F. to 290° F.;
5. Cooling the extruded mixture by introducing ambient air flow into a mixing chamber;
6. Providing the extruded mixture as a feed supplement.

One advantage to this process is the preparation of a stable, omega-3 fatty acid enriched feed supplement utilizing whole, wet microalgal biomass as an ingredient. Another advantage to this process is the use of a continuous mixer having a mixing extruder. This allows for the constant and even blending of the wet microalgal biomass with the absorbent porous mineral to prepare a flowable microalgae-mineral ingredient for use as an ingredient in subsequent mixtures.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention. Accordingly, the drawings and detailed description are to be regarded as illustrative in nature and not as restrictive.

### BRIEF DESCRIPTION OF DRAWINGS

Aspects are illustrated by way of example, and not by way of limitation, in the accompanying drawings, wherein:

FIG. 1 depicts a schematic of a feed supplement manufacturing components.

FIG. 2 depicts a flow chart for a feed supplement manufacturing process.

FIG. 3 depicts a flow chart for a soil amendment manufacturing process.

### DETAILED DESCRIPTION

The known methods for increasing omega-3 fatty acids in livestock feed generally require expensive, energy-intensive steps for processing the algae biomass, such as dewatering the algae or isolating the fatty acids. As noted above, it remained for the present inventor to recognize that unprocessed, whole algal biomass can be combined with a porous mineral and extruded to form a feed or feed supplement for livestock without the expensive algae processing steps.

The livestock feed comprises a mixture of the porous mineral and a whole algal biomass containing between 2.0% to 15.0% solids. This whole algal biomass can be the unprocessed product of open pond algae cultivation. The porous mineral can be selected from the group consisting of zeolite, bentonite, or a mixture of zeolite and bentonite. The whole algal biomass and the porous mineral are mixed together at a ratio of 1 part whole algal biomass to between 1 to 3 parts porous mineral. Alternatively, the whole microalgal biomass can be mixed with the porous mineral at a ratio of 1 part microalgal biomass to 1 to 4 parts porous mineral. Alternatively, the ratio of whole microagal biomass to zeolite can be 1:1, 1:2, 1:3, 1:4, 2:3, or a range in between these ratios.

The extruded mixture can be formed by dry extruding the whole algal biomass and the porous mineral together, with or without additional ingredients. The dry extruded mixture of whole algal biomass and the porous mineral can be delivered as a feed supplement or can be further processed into a final feed composition. The feed supplement may comprise:
a. Zeolite 2.5% to 12%;
b. Microalgal biomass 1.0% to 7.5%;
c. Flax between 40% to 60%;
d. A dry feed composition between 35% to 55%.

In order to provide algal biomass containing between 2.0% to 15.0% solids, a dewatering step may be needed. Certain microalgae grow to different density levels. For example, Nannochloropsis oculata may be cultivated to a concentration of 1 gram per liter to 3 grams per liter. In order to concentrate the algae to 6.0% to 15.0% solids, a dewatering step is employed. The step of dewatering a microorganism biomass can comprise flocculation, decanting, centrifugation, or filtration. In a preferred embodiment, the step of dewatering the algae comprises flocculation, filtration, decanting, or a combination thereof. At 15.0% solids, the algal biomass is flowable, pumpable, and mixable.

As discussed above, the cost of further dewatering the algal biomass increases the resulting price of any resulting feed product. Dewatering the algal biomass is more efficient by first mixing the wet algae with zeolite in a ratio between 1:0.5 and 1:3 and then dry extruding the mixture at between 270° F. to 290° F. The zeolite absorbs a portion of the water of the whole, wet microalgal biomass. The step of dry extruding the mixture further dehydrates the mixture and may also increase the fatty acid bypass of the resulting feed.

Photosynthetic microalgae are typically grown in dilute solution in water with appropriate minerals and nutrients. Nannochloropsis, as described in this disclosure, are grown in an appropriate mineral composition from 8 to 40 kg of sea salt per ton of water (8 to 40 parts per thousand total dissolved solids). The seawater mineral composition may be natural (diluted or concentrated seawater) or may be approximated using a combination of sodium chloride, magnesium chloride, calcium chloride, sodium bromide, sodium bicarbonate, and other trace minerals. Nutrients consist of a nitrogen source, a phosphorous source, carbon dioxide, and an iron source; in this work nitrogen was supplied as urea or UAN (urea-ammonium-nitrate). Nitrogen nutrients can be added to maintain a level of approximately 100 parts per million nitrogen; the exact concentration changes continuously and algal productivity is insensitive to exact levels as long as the concentration of nitrogen is maintained between 50 and 200 parts per million. Phosphorus can be added as phosphoric acid to maintain a level of between 20 and 50 parts per million phosphorus in water. The pH of the culture is continuously monitored. The pH is maintained between 7.0 and 8.5 by addition of gaseous carbon dioxide. Nitrogen can be added as a mixture of iron (II) chloride and ethylenediaminetetraacetic acid (EDTA). Other nutrient delivery mechanisms and chemical constituents are described in the art.

A microalgal biomass comprising Nannochloropsis may have a fatty acid composition as follows:

Nannochloropsis sp. fatty
acid composition

| | % on ash-free dry |
|---|---|
| Fatty acid | weight basis |
| C12:0 | 0.12% |
| C14:0 | 0.95% |
| C14:1 | 0.00% |
| C16:0 | 3.40% |
| C16:1 w7 | 4.22% |
| C16:1 w9 | 0.13% |
| C16:2 w6 | 0.20% |
| C16:2 w4 | 0.06% |
| C18:0 | 0.01% |
| C18:1 | 0.50% |
| C18:2 Linoleate | 0.21% |
| C18:3 GLA | 0.13% |
| C18:3 alpha linolenate | 0.00% |
| C20:0 | 0.00% |
| C20:1 | 0.00% |
| C20:2 11-14 Eicosenoiate | 0.00% |
| C20:3 Homogamma | 0.13% |
| Linolenate | |
| C20:4 Arachidonate | 0.75% |
| C20:3 11-14-17 | 0.00% |
| eicosatnenoate | |
| C20:5 EPA | 5.52% |
| C22:0 | 0.00% |
| C22:6 DHA | 0.00% |
| Total Fatty Acids | 16.33% |

Other algae may be grown in fresh water, or in conditions with higher salt concentration. Dunaliella salina may be grown in near-saturated brine solution. The algae may also be grown via fermentation in closed vessels utilizing fixed carbon sources such as glucose, glycerol, or cellulosic sugars.

When grown photosynthetically, microalgae are present in the culture in dilute suspension. Typically the microalgae are present at between 0.2 and 1.5 grams of ash-free dry weight per liter of culture. To concentrate the algae to a final slurry, a variety of techniques may be used. Dewatering methods include flocculation and settling, flocculation and dissolved air floatation, centrifugation, filtration, electroflocculation, and ultrasonic flocculation. These methods may be applied singly or in combination. The concentrated biomass may be rinsed with fresh water to remove excess salts, or may be utilized without rinsing.

In another embodiment, a dried algal biomass may be prepared. A dried biomass has a very low moisture content (<15% moisture). Preparation of a dried algal biomass may include the processing by rotary drum drying, roto-mill drying, paddle drying, solar drying, or other drying methods; the dried algal biomass may be milled or used as-is, and added dry to the batch mixer, or the dried biomass may be rehydrated to produce a 5-15% solids in water slurry. The dried microalgal biomass of Nannochloropsis may have the following characteristics:

| Nannochloropsis sp. | | |
|---|---|---|
| composition—dried | | |
| | As- | % on ash-free dry |
| | measured | weight basis |
| Protein (% N * 6.25) | 30.13% | 45.65% |
| Ash | 32.60% | 0.00% |
| Crude Fat (Acid | | |
| hydrolysis) | 12.40% | 18.79% |
| Moisture | 1.44% | 0.00% |
| Tryptophan | 0.28% | 0.42% |
| Lysine | 1.13% | 1.71% |
| Methionine | 0.41% | 0.62% |

Different microalgal species and growing conditions may result in whole, wet microalgal biomass containing different percentage solids. In one embodiment, the microalgal biomass contains between 2-7% solids. In another embodiment, the pond algae harvested to between 8-12% solids. Nannochloropsis is a genus of algae. The specific species of Nannochloropsis utilized may include N. gaditana, N. granulata, N. limnetica, N. oceanica, N. oculata, or N. salina, or a combination of species. Other species or genera having similar characteristics, including fatty acid profiles, may be used.

The porous mineral can be selected from the group consisting of zeolite, bentonite, or a mixture of zeolite and bentonite. Zeolite is a hydrous sodium aluminosilicate that is provided industrially as granules and powders. The general chemical formula for Zeolite is Na₆[Al₆Si₃₀O₇₂]₂₄H₂O. Zeolite powder, such as the zeolite powder manufactured by KMI Zeolite Inc., is provided with pore diameter between 4.0-7.0 angstroms and having a specific surface area of 40 m²/g and a pH of 7.0. The Food and Drug Administration considers Zeolite as GRAS (Generally Regarded As Safe) and useful as an anti-caking agent.

Zeolite powder is available at different mesh sizes. In a preferred embodiment of the innovation, 40-mesh zeolite powder is provided for blending with the wet whole algal biomass. 40-mesh zeolite powder corresponds to approximately 400 micron particle size. Alternatively, the zeolite powder may be provided at 20 mesh or 60 mesh or 80 mesh, or a combination of these mesh sizes. A typical chemical analysis of Zeolite is: SiO₂ 66.7%; Al₂O₃ 11.48%; Fe₂O₃ 0.9%; CaO 1.33%; MgO 0.27%; Na₂O 3.96%; K₂O 3.42%; MnO 0.025%; TiO₂ 0.13%. Zeolites have capacity to exchange cations. The following are major exchangeable cations: Rb⁺, Cu⁺², Na⁺, Co⁺³, Ba⁺², Cs⁺, Mg⁺², Pb⁺², Li⁺, Ca⁺², Ag⁺, AI⁺³, Sr⁺², NH⁺⁴, Fe⁺³, Zn⁺², K⁺, Hg⁺², Cd⁺², and Cr⁺³. In one embodiment, zeolite is provided at between 2.0% to 12% of the feed supplement. In other embodiment, zeolite is provided at between 8% to 14%, 6% to 12%, 6% to 8%, 4% to 8%, 2% to 6%, or 4% to 10% of the feed supplement.

Zeolite is a tectosilicate capable of taking up substantial amounts of water and other chemicals. Zeolite has an open crystal structure with a three-dimensional framework of [SiO₄] and [AlO₄] tetrahedra. This framework provides open cavities, channels and cages that admit water and positively charged ions. Zeolite is formed naturally along with volcanic ash. Zeolite can also be synthetically formed. Zeolites generally have a lower hardness and lower density than other tectosilicates.

The group of porous minerals also comprise aluminosilicate minerals, sodium bentonite, montmorillonite clay, halloysite, magnesium silicate hydroxide, a kaolinite mineral, a member from the montmorillonite/smectite group, a member of the illite group, a member of the chlorite group, and a combination thereof. The kaolinite minerals are layered silicate minerals having a chemical formula of chemical composition Al₂Si₂O₅(OH)₄. The Zeolite is also identified as a desiccant-type molecular sieve. The group of desiccant-type molecular sieves also comprise calcium oxide, montmorillonite clay and calcium sulfide. Other clay minerals include kaolinte, montmorillonite, illite, vermiculite. Other GRAS silicates include: aluminum calcium silicate, calcium silicate, diatomaceous earth, magnesium silicate, perlite, potassium silicate, silica aerogel, silicon dioxides, sodium aluminosilicate, sodium calcium aluminosilicate, sodium silicate, talc, tricalcium silicate. In one embodiment, the mineral is provided at between 2.0% to 12% of the feed supplement. In other embodiment, the mineral is provided at between 8% to 14%, 6% to 12%, 6% to 8%, 4% to 8%, 2% to 6%, or 4% to 10% of the feed supplement.

Flax is a common food crop and commodity, referring to the flaxseed. Flaxseed is commonly used in cattle feed. Whole flaxseeds are stable, but unprocessed ground flaxseed can become rancid from oxidation. Extruding the ground flax may protect against rancidity. In addition to being rich in omega-3 fatty acids, flax seed contains other fats, fiber, and protein. All of these components contribute to the feed supplement. Flax can be provided between 40% to 60%, 45% to 55%, 40% to 50%, or 50% to 60% of the feed supplement. In one embodiment, chia seed, rice bran, camelina meal, cottonseed meal may be substituted for the flax seed. Substitution of these ingredients may require recalibration of the percentages of other ingredients to maintain the nutrient profile. Flaxseed oil may be substituted for flaxseed, thereby providing the omega-3 fatty acids. The protein and fiber contributions could be compensated with additional dry product or with alternative sources.

The flax can be added to the mixture prior to the high temperature extrusion. Flax provides a source of plant-based omega-3 fatty acids, specifically alpha-linolenic acid (ALA). The animal consumes the plant-based omega-3 fatty acid in addition to the aquatic sourced omega-3 fatty acids from the microalgal biomass.

A final feed composition utilizing the extruded mixture of whole algal biomass and the porous mineral may also comprise flax and a dry feed composition. The amount of flax in the final feed composition can be between 40% to 60% of the feed supplement. In another embodiment, the amount of dry feed composition can be between 35% to 55%, 30% to 50%, 30% to 40%, 40% to 60%, 50% to 60%, of the feed supplement. The dry feed composition can be selected from the group consisting of wheat middlings, whole wheat, ground soy hulls, ground rice hulls, corn feed and mixtures thereof.

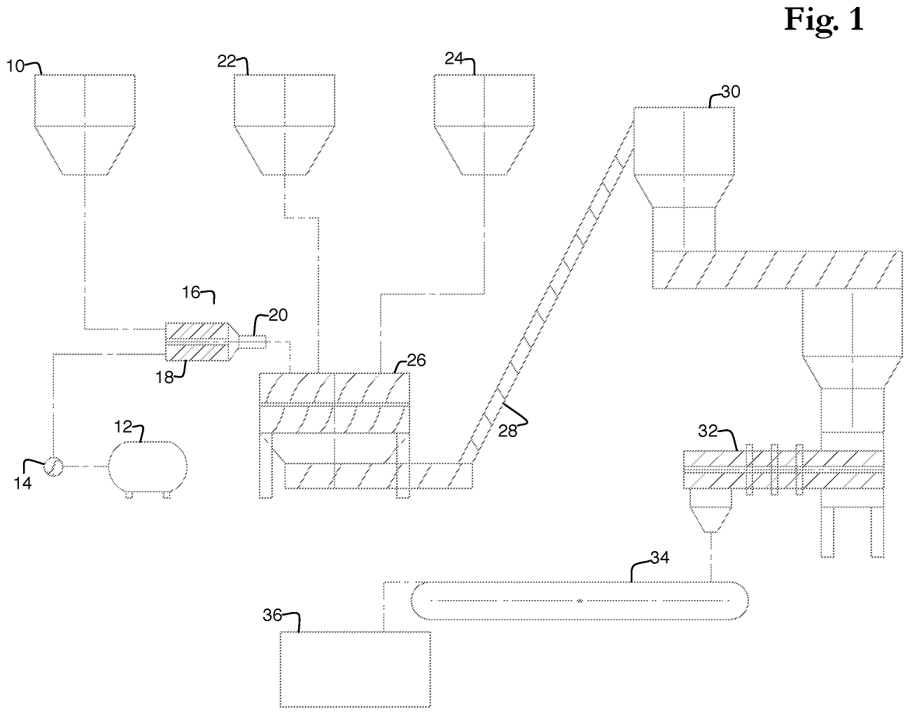

FIG. 1 shows a schematic of a process for making an animal feed comprising an extruded mixture of a microalgal biomass and a porous mineral. The porous mineral, such as zeolite, is provided in a mineral hopper 10. The zeolite can be transferred from mineral hopper 10 to the continuous mixing extruder 16 by an auger, belt conveyor, air conveyor, or other transfer methods. Alternatively, the mineral hopper 10 can be disposed above the continuous mixing extruder 16 such that the zeolite flows under the force of gravity from a gated opening at the bottom of the mineral hopper 10.

The whole, wet microalgal biomass is provided in algae tank 12. The microalgal biomass is transferred from the algae tank 12 by pumping the microalgal biomass with a pump 14 through a fluid connection between between the algae tank 12 and the continuous mixing extruder 16. Alternatively, the microalgal biomass can be contained in a keg, shuttle (such as a 200 gallon shuttle), or tank (such as a 300 gallon stainless steel tank). The pump 14 can be a fixed rate pump or a variable rate pump. The pump 14 can be a centrifugal, diaphragm, gear, lobe, peristaltic, progressive cavity, screw, or submersible pump. The pump could also be substituted by pressurizing the liquid in the supply tank.

The microalgal biomass is combined with the zeolite at the continuous mixing extruder 16. The microalgal biomass and zeolite are combined at a determined ratio. The ratio of microalgal biomass to zeolite can be 1:1, 1:2, 1:3, 1:4, 2:3, or other ranges in between these ranges. The ratio of the microalgal biomass to zeolite may vary depending on the density, percent solids, or fatty acid composition of the microalgal biomass. The microalgal biomass can be metered through a flow meter, a mass flow meter, or a scale. The zeolite can be metered by a scale, such as storing the zeolite in a weigh hopper. The continuous mixing extruder 16 has a hopper portion 18 and an augering extruder portion 20. The zeolite is deposited into the hopper portion 18. The augering extruder portion 20 shear mixes the microalgal biomass with the zeolite. An example of a continuous mixing extruder 16 is the ToughTek™ Machine Technologies D35 Continuous Mixer. In one embodiment, the flow rate of the microalgae-zeolite ingredient from the continuous mixer is 8-18 gallons per minute. In one example, the zeolite is mixed into the microalgae biomass to form 450 lbs of the microalgae-zeolite ingredient in less than 30 minutes, less than 10 minutes, or less than 5 minutes. A water flow gauge can be used to regulate the flow of microalgal biomass. The mixture of the microalgal biomass and zeolite is deposited into a batch mixer 26.

The batch mixer 26 receives the microalgae-zeolite from the continuous mixer extruder 26. Additional material can be added to the batch mixer 26. As illustrated in FIG. 1, a dry feed from a dry feed hopper 22 and flaxseed—whole or ground—from a flax hopper 24 can be transferred into the batch mixer 26. Respective contents can be transferred from the dry feed hopper 22 and the flax hopper 24 by an auger, belt conveyor, air conveyor, or other transfer methods. Alternatively, one or more hoppers can be disposed above the batch mixer 26 such that the contents flow under the force of gravity from a gated opening at the bottom of the hopper.

The mixture is transferred from the batch mixer 26 to an intermediate hopper 30. The intermediate hopper 30 feeds an extruder 32. The material is transferred by a conveyor 28 such as an auger, belt conveyor, air conveyor, or other transfer methods. Alternatively, the batch mixer 26 can be disposed above the intermediate hopper 30 such that the contents flow under the force of gravity from a gated opening at the bottom of the hopper.

The mixture is then extruded at the extruder 32 to form the feed supplement. Extruding at the extruder 32 subjects the mixture to increased temperature and pressure. Dry extruding the mixture reduces the moisture content and stabilizes the mixture. The temperature of the material is increased to between 270° F. to 300° F. In another embodiment, the temperature of the material is increased to above 212° F., to above 260° F., to less than 330° F., or to between 212° F. and 350° F. In dry extrusion, the extruder uses a mechanical process to generate heat and pressure. The extruder heats the mixture to the point of gelatinization, cooking, dehydrating, and stabilizing the mixture. Alternatively, the extruder can utilize steam or other wet heat source to assist in the heating process. Additional cooling and drying time may be necessary to dry the extruded feed supplement if additional moisture is introduced with steam. The temperature of the mixture during the step of extruding reaches at least 270° F. In one embodiment, the mixture is retained in the extruder barrel for a retention time of between four to five seconds. In another embodiment, the retention time in the extruder barrel is less than 30 seconds, less than 10 seconds, or less then 5 seconds.

The extruded material is then transferred to a cooling and drying unit 36 by an extruded material conveyor 34. The cooling and drying unit 36 introduces ambient or conditioned air, to decrease the temperature and remove moisture from the extruded feed supplement. Rapidly decreasing the temperature may preserve the nutrients and microalgae.

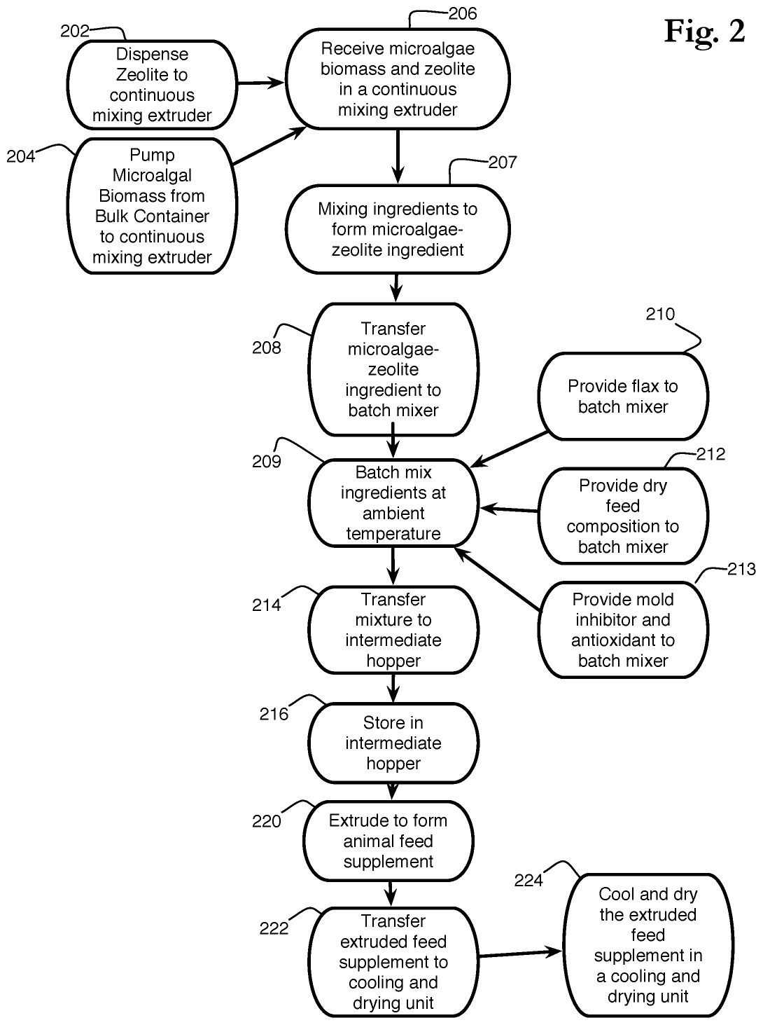

FIG. 2 shows a flow chart of a process for preparing an extruded feed supplement containing microalgal biomass and zeolite. Zeolite is dispensed in step 202. The microalgal biomass is pumped from a bulk container in step 204. The zeolite and the microalgal biomass are received into a continuous mixing extruder in step 206. The continuous mixing extruder mixes the ingredients to form a microalgae-zeolite ingredient in step 207. The microalgae-zeolite ingredient is transferred to a batch mixer in step 208. Flax is provided to the batch mixer in step 210. Dry feed composition is provided to the batch mixer in step 212. Mold inhibitor and antioxidant is provided to the batch mixer in step 213. The ingredients are mixed in the batch mixer at ambient temperatures in step 209. The mixture is then transferred to an intermediate hopper in step 214. The mixture may be stored in the intermediate hopper according to step 216. The mixture is extruded to form an animal feed supplement in step 220. The extruded feed supplement is then transferred to a cooling and drying unit in step 222. The extruded feed supplement is cooled and dried in a cooling and drying unit in step 224.

A method for making an animal feed can comprise the steps of
a. Providing an algal biomass containing between 2.0% to 15.0% solids, where the whole algal biomass can be the unprocessed product of open pond cultivation;
b. Providing a porous mineral, such as zeolite, bentonite, or a mixture of zeolite and bentonite;
c. Combining the algal biomass and the porous mineral, where a ratio of the algal biomass to the zeolite that is between 1:1 and 1:4;
d. Mixing the combined algal biomass and the porous mineral;
e. Extruding the mixture, such as a dry extrusion where the temperature of the mixture during the step of extruding reaches between 270° F. to 300° F.;
f. Cooling the extruded mixture;
g. Providing a dry feed composition, such as wheat middlings, whole wheat, ground wheat, ground corn, ground milo, ground soy, distillers solubles, ground soy hulls, ground rice hulls, corn feed and mixtures thereof;
h. Providing flax;
i. Mixing the extruded composition, dry feed composition, and flax wherein:
   1. the extruded composition makes up between 5% to 15% of a feed supplement;
   2. the dry feed composition makes up between 35% to 45% of the feed supplement;
   3. the flax makes up between 40% to 60% of the feed supplement.

In a first example, an animal feed product is made incorporating Nannochloropsis sp. and zeolite. In this example an animal feed product may be manufactured incorporating wheat, flax, algae, zeolite, and other ingredients according to the follow process. To produce a three-ton batch of feed, 2,645 pounds of wheat middlings were transferred to a horizontal batch mixer (Scott Equipment Company, New Prague, Minn.). A liquid slurry of 5% Nannochloropsis sp. algae in 15 parts per thousand sodium chloride solution (algae growth media) is mixed with zeolite (40 mesh Zeolite powder from KMI Zeolite Inc., Amargosa Valley, Nev.) at a ratio of 1:2 on a weight/weight basis using a continuous mortar mixer; the product from the continuous mixer is added directly to the wheat middlings in the batch mixer. Once 450 pounds of the algae-zeolite slurry was added to the mixer, 3,170 pounds of whole flax seeds, 3 pounds of 66% ethoxyquin powder, 6 pounds of vitamin E powder and 7.5 pounds of Mold-X 50 dry (Ag Research Inc.) mold inhibitor was added to the batch mixer and mixed. Once thoroughly mixed, the material is transferred to an intermediate hopper. From the intermediate hopper, the material is fed to an Insta-Pro 2000 series extruder (Insta-Pro, Des Moines, Iowa) adjusted to extrude the product at 2,000 pounds per hour. At steady state, a temperature of 285° Fahrenheit is achieved at the final extruder barrel segment, and the material spends an average time of four to five seconds in the extruder barrel. Once extruded, the material is cooled and dried in a cooling unit with ambient air to 6.3% moisture.

After manufacture, the product was analyzed at Servi-Tech Laboratories (Hastings, Nebr.) to determine composition. The final moisture content of the material was 6.3%, crude protein was 20.5%, crude fiber was 6.9%, and fat by acid hydrolysis was 24.8%. Separately, the material was analyzed in-house to determine fatty acid composition of the fat. The content of alpha-linolenic acid was 11.9%. The product was stored at room temperature with no protective packaging for eight months after manufacturing without developing off odors or other indications of rancidity. In normal animal feed manufacturing practice, flax seed cannot be pre-ground as exposure of the alpha-linolenic acid to air rapidly results in obvious rancidity. The extruded product is unexpectedly stable.

In a second example, an animal feed product is made incorporating dried seaweed meal and zeolite. In this example an animal feed product will be produced incorporating wheat, flax, algae, zeolite, and other ingredients. To produce a two-ton batch of feed, 2,000 pounds of wheat middlings will be transferred to a batch mixer. 50 pounds of Laminaria digitata powder (kelp meal, Thorvin Inc.) and 50 pounds of zeolite (KMI Zeolite Inc.) will be added to the batch mixer, along with 50 pounds of water, 2,000 pounds of whole flax seeds, 3 pounds of 66% ethoxyquin powder, 6 pounds of vitamin E powder and 7.5 pounds of Mold-X 50 dry (Ag Research Inc.) mold inhibitor and will be mixed for one hour. Once thoroughly mixed, the material will be transferred to an intermediate hopper. From the intermediate hopper, the material will be fed to a Wenger X-175 series single screw extruder with two cut-flight screw segments adjusted to extrude the product at 4,000 pounds per hour and reach a temperature of 285 degrees Fahrenheit. Once extruded, the material will be cooled in a counter-current dryer, such as a Colorado mining equipment cooler. The final moisture content of the material will be between 6% and 9%; alpha-linolenic acid content will be between 10% and 14%.

In a third example embodiment, the feed supplement can have a total percentage of fatty acids of 24.9%, a total calculated percent fat of 27.7%, omega-3 fatty acids of 12.11%, omega-6 fatty acids at 4.7%, a ratio of n6:n3 of 0.39, and a percentage of poly-unsaturated fated acids of 16.8%.

In a forth example embodiment, the feed supplement has a total percentage of fatty acids of 5.2%, a total calculated percent fat of 5.7%, omega-3 fatty acids of 1.7%, EPA and DHA at 0.01%, omega-6 fatty acids at 1.7%, a ratio of n6:n3 of 1.03, and a percentage of poly-unsaturated fated acids of 3.4%.

A feed blended for use with chickens can have a total percentage of fatty acids of 6.42%, a total calculated percent fat of 7.1%, omega-3 fatty acids of 1.09%, omega-6 fatty acids at 2.0%, a ratio of n6:n3 of 1.9; and a percentage of poly-unsaturated fatty acids of 3.1%.

A feed blended for use with cows can have a total percentage of fatty acids of 5.2%, a total calculated percent fat of 5.8%, omega-3 fatty acids of 1.8%, omega-6 fatty acids at 2.2%, a ratio of n6:n3 of 1.2; and a percentage of poly-unsaturated fatty acids of 4.0%.

In a fifth embodiment, the supplement is more highly concentrated. This more highly concentrated supplement has the advantage of lower transportation costs. A highly concentrated supplement could be supplied in forms such as bags and totes. A 2,000 pound batch of the highly concentrated formulation could comprise:
a. 450 pounds wet, whole microalgal biomass;
b. 600 pounds zeolite;
c. 100 pounds flax;
d. 850 pounds of the dry feed composition.

In a sixth embodiment, a concentrated product was produced incorporating algae slurry and zeolite at a high concentration, with sufficient flax and wheat to allow the material to be extruded properly. To produce a one-ton batch of concentrate, 850 pounds of wheat middlings were introduced to a horizontal batch mixer (Scott Equipment Company, New Prague, Minn.). Nannocholoropsis algae slurry (450 pounds) and zeolite (600 pounds) were mixed via a continuous mortar mixer and added to the batch mixer. Flax seed (100 pounds) was added to the mixer and mixed. Once thoroughly mixed, the material was transferred to an intermediate hopper. From the intermediate hopper, the material was fed to an Insta-Pro 2000 series extruder adjusted to extrude the product at 2,000 pounds per hour. At steady state, a temperature of 285 degrees Fahrenheit was achieved at the final extruder barrel segment. Once extruded, the material was cooled and dried to 19.3% moisture. The concentrate had a total fat content of 5.73%, with a total Omega-3 content of 1.65% and a total eicosapentaenoic acid content of 0.006%. The Omega-6 to Omega-3 fatty acid ratio of the material was 1.03.

A method for making a highly concentrated feed supplement can comprise mixing the products in a horizontal mixer, such as a 3 ton capacity Scott Mixer. From the mixer the combined ingredients are transferred to a holding tank. From the holding tank, the combined ingredients are transferred to bin that will charge the extruders on processing demand. From the Extruder the product goes to a cooler and dryer unit. In the cooler the product is cooled to ambient temperature and dried. The product is ready for storage at 8% moisture. The product could be stored in bulk storage or into 1 ton tote or 50 pound bags. The highly concentrated feed supplement can be added to commercial feed blends at a level of 100 pounds per ton of complete feed.

In one embodiment, the step of batch mixing 208 the ingredients lasts from 5 minutes to 15 minutes. In another embodiment, the step of mixing the ingredients lasts for less than 30 minutes. Alternatively, the ingredients are mixed for less than 15 minutes once the mixer is fully loaded with the ingredients to be mixed. The ingredients can be mixed for 8 minutes, 10 minutes, 12 minutes, or 15 minutes once the ingredients are fully loaded in the batch mixer 26.

In another embodiment, the stable, dry composition is of algae and a negatively charged porous mineral. In another composition, the microalgae are combined with a desiccant-type molecular sieve.

As illustrated in FIG. 1, the extruder 32 mechanically processes the feed, heating the mixture to the point of gelatinization as well as cooking, dehydrating, and stabilizing the mixture. A dry extruder, for example an Insta-Pro International® dry extruder may be used to increase the temperature of the mixture during the step of extruding to between 270° F. to 300° F. The temperature and pressure rises to gelatinize the feed supplement.

In another embodiment, the extruder 32 may be replaced with a heated pelletizer or a tablet press. Certain aspects of the extrusion process, such as the backflow characteristics of an Instapro extruder, can be generally replicated using other technologies and produce a similar extruded feed product. For example, a single screw extruder with steam with two cut-flight screw segments could be used. Increased drying time may be required in a steam extrusion process.

The feed supplement and final feed composition described above are useful for increasing levels of omega-3 fatty acids in animal products, such as beef, poultry, pork, eggs, and dairy. This increased level of omega-3 fatty acids is achieved by feeding the animal a total feed having between 5% and 10% of a feed supplement comprising an extruded mixture of algae and zeolite in a ratio between 1:1 and 1:3. The animals can be fed the supplement at between 5% and 15%, 2% to 8%, or 4% to 10% of the total feed.

A feeding regimen for laying hens involves supplementing their standard diet with between 2% and 10% of the feed supplement comprising the extrusion of microalgae-zeolite as described herein. For example, laying hens are fed a diet containing the feed supplement to produce omega-3 enriched eggs. The laying hens are fed a diet containing the feed supplement for 2 to 3 weeks prior to consistently producing an egg with increased Omega 3 content. At that time the laying hens may produce eggs having between 150 mg to 300 mg of omega-3 fatty acids. The level depends on the breed of laying hen, certain environmental factors, and the percentage of the present supplement in the diet. Additionally, the EPA/DHA levels will also range from 80 mg to 140 mg per egg. In one example of a feeding regiment, the feed will be supplemented with increasing percentage of the present feed supplement until the eggs start to become to big and shell quality starts to become a problem. Feeding the laying hens a feed containing 10% of the present feed supplement will produce an egg that has 300 mg of Omega 3 and 130 mg of long chain fatty acids. The present feed supplement can be fed in levels from 5% of the diet to 15% of the diet. In another example, broiler chickens are fed the present feed supplement to produce poultry meat enriched for omega-3 fatty acids. The broiler chicken are fed a diet containing 10% of the present feed supplement from day 19 of there growing cycle until they are slaughtered. In another example, turkeys are fed the present feed supplement to produce turkey meat enriched for omega-3 fatty acids. The turkeys are fed a diet containing 10% of the present feed supplement for the last 4 to 6 weeks of their finishing cycle. Changes to the birds' health is observable when the birds are fed a diet containing at least 5% of the present feed supplement.

Eggs from chickens fed a diet comprising an extruded mixture of microalgae, zeolite, flax and a dry feed product showed approximately a 10-fold increase in the EPA/DHA content per egg compared with eggs from chickens fed a standard layer diet. The increase in EPA/DHA was also significant compared with eggs from chickens fed a flax seed enriched diet, without the microalgae-zeolite ingredient. The eggs from the chickens fed a feed supplement comprising the algae and zeolite also showed a 6:3 ratio of fatty acids that was 3:1, an improvement over the 18:1 ratio in eggs from chickens fed a standard layer diet and also an improvement over eggs from chickens fed a flax seed enriched diet.

| | Omega-3 | EPA/DHA | Omega-6: |
|---|---|---|---|
| | Fatty Acids | (mg/ | Omega-3 |
| | (mg/large egg) | large egg) | Ratio |
| Standard layer diet | 40-50 mg | 25-30 mg | 18:1 |
| Flax seed enriched diet | 260-270 mg | 90-100 mg | 4.5:1 |
| Diet comprising | 325-335 mg | 140 mg | 3:1 |
| extruded mixture of | | | |
| algae and zeolite | | | |

After feeding a feed supplement comprising an extruded mixture of algae and zeolite to beef cattle, the beef product was analyzed for fatty acid profile.

| | | | | Supple- | Con- |
|---|---|---|---|---|---|
| Fatty | | | Unsat | mented | ventional |
| Acid | Name | Type | Position | Diet | Diet |
| 10:0 | Capric | Saturated | | 0.00014 | 0.0001 |
| 12:0 | Lauric | Saturated | | 0.00018 | 0.00015 |
| 14:0 | Myristic | Saturated | | 0.00744 | 0.00622 |
| 14:1 | Myristoleic | Monounsat | w5 | 0.00224 | 0.00118 |
| 15:0 | Penadecanoic | Saturated | | 0.00083 | 0.00099 |
| 16:0 | Palmitic | Saturated | | 0.0599 | 0.0491 |
| 16:1 | Palmitoleic | Monounsat | w7 | 0.00892 | 0.00494 |
| 17:0 | Heptadecanoic | Saturated | | 0.00181 | 0.0023 |
| 18:0 | Stearic | Saturated | | 0.0336 | 0.0382 |
| 18:1 | Oleic | Monounsat | w9 | 0.0725 | 0.066 |
| 18:2 | Linoleic | Polyunsat | w6 | 0.00467 | 0.00761 |
| 18:3 | Linolenic | Polyunsat | w3 | 0.0007 | 0.00038 |
| 20:0 | Arachidic | Saturated | | 0.00027 | 0.00026 |
| 20:1 | Eicosenoic | Monounsat | w9 | 0.00033 | 0.0004 |
| 20:3 | Homogamma | Polyunsat | w6 | 0.00029 | 0.00026 |
| | linolenic (n6) | | | | |
| 20:4 | Arachidonic (n3) | Polyunsat | w3 | 0 | 0 |
| 20:4 | Arachidonic (n6) | Polyunsat | w6 | 0.00038 | 0.00046 |
| 20:5 | Eicosapentaenoic | Polyunsat | w3 | 0 | 0 |
| 22:0 | Behenic | Saturated | | 0 | 0 |
| 22:4 | Docosatetraenoic | Polyunsat | w6 | 0.0001 | 0.00013 |
| 22:5 | Docosapentaenoic | Polyunsat | w3 | 0.00018 | 0 |
| | (n3) | | | | |
| 22:6 | Docosahexaenoic | Polyunsat | w3 | 0 | 0 |

| | | |
|---|---|---|
| Grams of total fat per 100 g serving | 19.448 | 17.868 |

The ratio of omega-6:omega-3 fatty acids in the beef from cattle fed the supplemented diet was 6.2 whereas beef from cattle fed a conventional diet had a 6:3 ratio of 22.3.

It is also possible to produce pork having an increased amount of omega-3 fatty acids. Pork when produced to supply a omega 3 enriched protein source will be fed a hog finisher diet that contain 10% of the feed supplement. Hogs should be fed for a minimum of 6 weeks on this diet to achieve an increased level of omega-3 fatty acids. One advantage to feeding hogs the feed supplement is improvements in the hogs' health, reproduction and performance the following feeding program. In one example, sows should be fed a farrowing sow diet containing 5% feed supplement per ton of feed for 3 weeks prior to farrowing and remain on that diet until the sow is rebred. When the sow is in a dry state the sow should be fed a diet containing 2½% feed supplement. In another example, nursery pigs should be on a diet containing 5% feed supplement until they are out of the nursery and into the growing barns. In the growing barns hogs should be fed a diet containing 2½% feed supplement. In another example, boers should be fed a diet containing 2½% GO. This feed supplement may add to the activity of the sperm produced.

Pork comparison results on Fatty Acids in Pork Tenderloin

| | | | | | | EPA | |
|---|---|---|---|---|---|---|---|
| | | | | | | & | Omega- |
| | | | | | Ration | DHA | 3 Fatty |
| | | | | | Omega- | per | acids |
| | | Percent | Omega- | Omega- | 6/Omega- | 100 | mg per |
| | Total | Omega- | 3 as | 6 as | 3 | gram | 4 oz |
| | Calculated | 3 fatty | percent | percent | Fatty | serving | serving |
| | % Fat | acids | of fat | of fat | Acids | (mg) | portion |
| Control | 4.97% | 0.04% | 0.91% | 0.84 | 18.60/1 | 6.37 | 50.98 |
| 6.3% Feed | 4.33% | 0.11% | 2.46% | 0.8 | 7.63/1 | 9.65 | 120.37 |
| Supplement | | | | | | | |
| 10% Feed | 6.78% | 0.29% | 4.21% | 1.21% | 4.33/1 | 18.77 | 323.82 |
| Supplement | | | | | | | |

In humans, healthy levels of omega fatty acids may help prevent heart disease, prevent strokes, control lupus, control eczema, help rheumatoid arthritis, and play a protective role in cancer and other conditions. Other benefits of healthy levels of omega fatty acids include benefiting babies and children in brain development, optic development, and general health. In adults, benefits of healthy levels of omega fatty acids include helping to prevent cardiovascular problems, encourage optical health, and develop brain function and general health.

In animals, healthy levels of omega fatty acids provide similar benefits. Animals fed a diet containing healthy levels of omega fatty acids are improved in herd health, production and reproduction performance. In dairy animals, feeding dairy animals a diet rich in omega fatty acids can increase milk volume by up to 5 pounds. This can occur without change in the overall milk composition. Feeding an extruded mixture of microalgae and zeolite improved herd health in general. The physiological condition of a human or animal can be improved by administering orally biologically effective amount of a stable, dry composition of the extruded mixture of algae and zeolite.

As discussed above, humans and many livestock are poor converters of ALA to DHA/EPA. Feeding the human or livestock an extruded mixture of algae and zeolite might increase the conversion rate of ALA to DHA/EPA. The conversion rate of an animal comprises feeding the animal a biologically effective amount of a stable, dry composition of algae and an aluminosilicate, such as zeolite, might improve the animal's ability to convert ALA to DHA/EPA.

One advantage to feeding the feed supplement is the increased digestibility of the feed. The extrusion comprising the microalgae-zeolite ingredient might increase the digestibility of the fatty acids of the feed supplement, thereby improving the animal's health.

Additional ingredients for use in the feed supplement or a final feed composition comprise mold inhibitors and anti-oxidants. For example, approximately 2% of the feed supplement or final feed composition may be comprised of a mold inhibitor and an anti-oxidant.

In one embodiment, the porous mineral is zeolite. In another embodiment, the porous mineral is clinoptilolite. Clinoptilolite is a naturally occurring zeolite having a chemical formula of (Na,K,Ca)₂₋3Al₃(Al,Si)₂Si₁₃O₃₆.12H₂O. Clinoptilolite has ion exchange properties a strong exchange affinity for ammonium (NH₄).

Different micro-algae species have different advantages. In one embodiment, the growth and composition characteristics of Nannochloropsis oculata may be advantageous. In another embodiment, the growth and composition characteristics of a species in the Arthrospira genus may be advantageous. Species of the Arthrospira genus that may be advantageous include Arthrospira platensis and Arthrospira maxima, also known as spirulina. Other embodiments may employ other cyanobacterium, or combinations of cyanobacterium and microalgae, that have advantageous growth or composition characteristics.

In addition to humans and livestock, soil health may also benefit from the addition of a mixture of zeolite and algal biomass. Without wanting to be bound to a particular theory, the porous mineral may cut fertilizer and water costs by storing nutrients, such as ammonium, and water in the soil for the plants to utilize. This may also decrease ammonium run off and decrease water pollution.

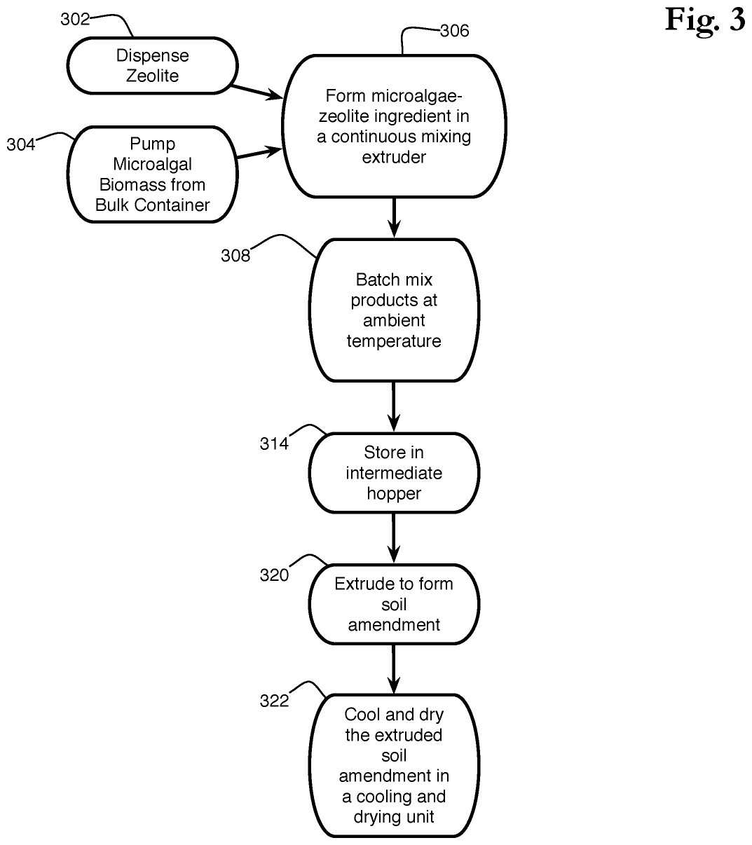

FIG. 3 shows a flow chart of a process for preparing an extruded soil amendment. Zeolite is dispensed according to step 302. The microalgal biomass is pumped from the bulk container according to step 304. In a continuous mixing extruder, the microalgal biomass and the zeolite are formed into a microalgae-zeolite ingredient according to step 306. The products are mixed at ambient temperature according to step 308. The mixed products can be stored in an intermediate hopper according to step 314. The soil amendment is formed by extrusion according to step 320. The extruded soil amendment is cooled and dried in a cooling and drying unit according to step 322.

In one embodiment, the soil amendment comprises:
a. A dry extruded mixture of:
   i. an algal biomass having between 6.0% to 18.0% solids;
   ii. a porous mineral.

In another embodiment, the soil amendment may be one of the above-described animal feed supplement compositions.

A method for preparing a soil amendment comprises:
A. Cultivating a microorganism, such as an algae, the algae Nannochloropsis oculata, a cyanobacterium, or a Spirulina cyanobacterium;
B. Harvesting the microorganism biomass;
C. Dewatering the microorganism biomass to between 6.0% to 15.0%;
D. Mixing the dewatered microorganism with zeolite;
E. Co-extruding the mixture;
F. Providing dry organic composition, such as wheat middlings, whole wheat, ground wheat, ground corn, ground milo, ground soy, distillers solubles, soy hulls, rice hulls, corn feed and mixtures thereof.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention. Accordingly, the drawings and detailed description are to be regarded as illustrative in nature and not as restrictive.

1. A method for making a feed supplement for animals, the method comprising:
a. providing a microalgae-mineral ingredient comprising:
i. a microalgal slurry; and
ii. a porous mineral at between 1.0% to 12% of the feed supplement;
b. providing a first mixture comprising the microalgae-mineral ingredient; and
c. extruding the first mixture to form the feed supplement.

2. The method of claim 1, wherein the microalgal slurry is provided at between 1.0% to 7.5% of the feed supplement.

3. The method of claim 2, the microalgal slurry having between 2.0% to 15.0% solids.

4. The method of claim 1, the first mixture further comprising:
a. a quantity of flax seed at between 40% to 60% of the feed supplement; and
b. a dry feed composition between 35% to 55% of the feed supplement, wherein the dry feed composition is selected from the group consisting of wheat middlings, whole wheat, ground wheat, ground corn, ground milo, ground soy, dried distillers grains with solubles, ground soy hulls, ground rice hulls, corn feed and mixtures thereof.

5. The method of claim 4, the step of providing the microalgae-mineral ingredient further comprising:
a. dispensing the porous mineral into a continuous mixing extruder, where the porous mineral is a zeolite;
b. pumping the microalgal slurry into the continuous mixing extruder; and
c. forming the first mixture in the continuous mixing extruder.

6. The method of claim 5, wherein the step of extruding comprises dry extruding the first mixture and heating the first mixture to a temperature between 270° F. to 300° F.

7. The method of claim 6, wherein the microalgal slurry is provided at between 1.0% to 7.5% of the feed supplement, and the microalgal slurry is a product of open pond cultivation and contains between 2.0% to 15.0% solids.

8. The method of claim 1, wherein the step of providing the microalgae-mineral ingredient further comprises:
i. dispensing the porous mineral into a continuous mixing extruder;
ii. pumping the microalgal slurry into the continuous mixing extruder; and
iii. shear mixing the porous mineral and the microalgal slurry in the continuous mixing extruder thereby forming the microalgae-mineral ingredient.

9. The method of claim 4, further comprising:
a. batch mixing the microalgae-mineral ingredient with the quantity of flax seed and the dry feed composition prior to the step of extruding.

10. A process for preparing a feed supplement for animals comprising the steps of:
a. providing a microalgae-mineral ingredient comprising:
i. one part of a microalgal slurry; and
ii. between two and four parts of a porous mineral; and
b. forming the microalgae-mineral ingredient into the feed supplement at an elevated heat and pressure.

11. The process of claim 10, wherein:
a. the porous mineral is an aluminosilicate.

12. The process of claim 10, wherein:
a. the porous mineral is zeolite having a particle size of 250 microns to 850 microns.

13. The process of claim 10, wherein the step of providing the microalgae-mineral ingredient further comprises:
a. wherein the microalgal slurry contains between 2.0% to 15.0% solids;
b. adding the porous mineral to a hopper of a continuous mixer;
c. pumping the microalgal slurry into the continuous mixer; and
d. forming the microalgae-mineral ingredient through shear mixing.

14. The process of claim 13, further comprising the steps of:
a. providing a quantity of flax seed at between 40% to 60% of the feed supplement; and
b. providing a dry feed composition between 35% to 55% of the feed supplement, wherein the dry feed composition is selected from the group consisting of wheat middlings, whole wheat, ground wheat, ground corn, ground milo, ground soy, dried distillers grains with solubles, ground soy hulls, ground rice hulls, corn feed and mixtures thereof.

15. The process of claim 14, further comprising:
a. batch mixing the microalgae-mineral ingredient with the quantity of flax seed and the dry feed composition prior to the step of forming.

16. The process of claim 13, wherein:
a. the microalgal slurry comprises a species of Nannochloropsis.

17. The process of claim 10, further comprising:
a. heating the microalgae-mineral ingredient to a temperature of between 270° F. to 300° F.; and
b. cooling the feed supplement after the step of forming.

18.-24. (canceled)

25. The process of claim 10, wherein:
a. the porous mineral is a magnesium silicate.

26. A process for preparing a feed supplement comprising the steps of:
a. dewatering a first microalgae slurry to a concentrated microalgal slurry having between 2.0% to 15.0% solids; and
b. extruding the concentrated microalgal slurry to produce the feed supplement.

27. The process of claim 26, further comprising the step of:
a. mixing the concentrated microalgal slurry with a porous mineral prior to the step of extruding.

28. The process of claim 27, further comprising the step of:
a. adding a dry organic composition between 35% to 55% of the feed supplement prior to the step of extruding.
